(19) United States
(12) Patent Application Publication
(10) Pub. No.: US 2011/0300392 A1
(43) Pub. Date: Dec. 8, 2011

(54) METHOD OF MANUFACTURING FLOOR PANELS CONTAINING WOOD/PLASTIC COMPOSITE, AS WELL AS SUCH PANELS

(75) Inventor: Bruno Paul Louis Vermeulen, Aldeneik-Maaseik (BE)

(73) Assignee: SPANOLUX N.V.-DIV. BALTERIO, Sint-Baafs-Vijve (BE)

(21) Appl. No.: 13/144,604

(22) PCT Filed: Jan. 14, 2010
(86) PCT No.: PCT/EP10/50422

§ 371 Date: Aug. 24, 2011

(30) Foreign Application Priority Data
Jan. 15, 2009 (EP) 09150647.7

(51) Int. Cl. B32B 27/06; B32B 21/04; B27N 3/02

(52) U.S. Cl. 428/513; 156/62.2; 428/537.1

(57) ABSTRACT

A method of manufacturing floor panels comprising at least one layer containing wood/plastic composite (WPC) adjacent an upper surface of the panels includes the step of providing a granulate of WPC in which natural fibers are encapsulated in polymer plastics which has been colored to a desired color for the upper surface. To form a sheet, a layer of granulate is melted and pressed. If several layers are used, only the upper layer is colored. The sheet is finished to form one or more panels. The coloring is done to imitate natural materials at least on the upper surface of the panel. Additional features can be taken to improve the appearance of the upper surface.

### CROSS-REFERENCE TO RELATED APPLICATION

This application is a Section 371 National Stage Application of International Application PCT/EP2010/050422 filed Jan. 14, 2010 and published as WO/2010/081860 A1 in English.

### BACKGROUND

The discussion below is merely provided for general background information and is not intended to be used as an aid in determining the scope of the claimed subject matter.

Aspects of the invention relate to a method of manufacturing floor panels comprising at least one layer containing wood/plastic composite (WPC) adjacent an upper surface of the panels.

A method as described above is for example known from WO 2008/122668 A1. This document discloses flooring products and methods of making the same.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

An aspect of the present invention provides a new method of making such floor panels. In one embodiment, a method of manufacturing floor panels comprising at least one layer containing wood/plastic composite (WPC) adjacent an upper surface of the panels, includes providing a granulate of WPC in which natural fibers are encapsulated in polymer plastics which has been colored to a desired colour for the upper surface, providing a layer of granulate and melting the granulate to form a melted layer, pressing the melted layer, together with any other layer, for forming a sheet, and finishing the sheet to form one or more panels.

An aspect of the invention also provides floor panels which are easy to manufacture and very well recyclable. In one embodiment, a panel having an upper surface, comprises at least one layer of wood/plastic composite (WPC) which is made from colored granulate, preferably to imitate natural materials at least on the upper surface of the panel.

### BRIEF DESCRIPTION OF THE DRAWING

FIG. 1 is a schematic perspective view of a panel.

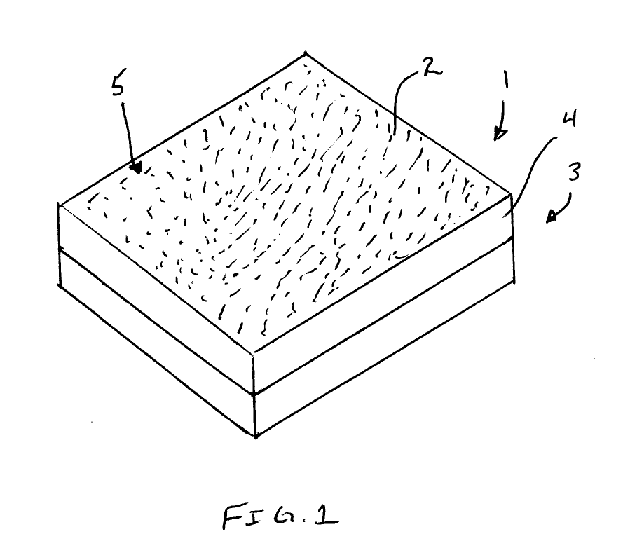

### DETAILED DESCRIPTION OF THE ILLUSTRATIVE EMBODIMENT

A method of manufacturing a floor panel 1 includes steps of providing a granulate of WPC in which natural fibers are encapsulated in polymer plastics which has been colored to a desired color for an upper surface 2, providing a layer of granulate and melting it, pressing the melted layer, together with any other layer, for forming a sheet, and finishing the sheet to form one or more panels 1.

This is an easy and low cost manner of manufacturing floor panels while this method also enables to grind the panels at the end of their lifecycle in order to be re-used again in other products, because the panels are preferably absent of other layers made of other materials.

If the panel 1 is constructed with a plurality of layers 3, either WPC layers or partly other layers, it would be sufficient to color treat only an upper layer 4 adjacent the upper surface 2 of the panel 1.

All kinds of additional measures could be taken to further improve the appearance of the panel, particularly to imitate natural materials such as wood, stone marble and the like.

First of all it is possible to scatter or press some type of plastic powder (synthetic ink) or pulverized granulate 5 onto the upper surface 2 to provide it with a decorative aspect. This provision could be done in a controlled manner to obtain a decorative effect by the spreading pattern, for example to obtain nuances in wood or stone or to obtain a fantasy effect by means of mica flakes or the like. Scattering could be done very accurate by existing apparatus (scattering-in-register or through templates). Differently colored particles could be provided to obtain the desired effects. Providing the colored powders or pulverized granulates could be done on the basis of particle size, shape, weight, type of plastic or structure.

The granulate 5 may include thermo sensitive particles or pigments providing a decorative aspect after activation by a temperature increase, in particular coloring effects.

An efficient manner of pressing is obtained when the melted WPC layer is pressed in a continuous process to form a continuous sheet web which is cut into separate sheets which are used as a basis to form one or more panels.

Making and finishing the panels include cutting the sheets into separate panels and also machining and finishing the edges of the panels in order to form coupling members and optionally locking members in order to enable the panels to be coupled to each other.

Furthermore an aspect of the invention includes the panel 1 comprising at least one layer 4 of wood/plastic composite (WPC) which is made from colored granulate 5 to imitate natural materials at least on the upper surface 2 of the panel 1.

An apparatus to perform the method could include a granulate supply including a mechanism which is adapted to supply a layer of granulate on a supporting conveyor belt.

The granulate is made from wood/plastic composite which is a material known in the prior art. It may include from about 30 wt % to about 95 wt % of at least one polymeric material and from about 5 wt % to about 80 wt % of at least one natural fiber or flour by weight of the core. The polymeric material can be one or more polymers having a polyolefin group, such as polyethylene. Other exemplary polymers include polypropylene, polyvinyl chloride, copolymer of PVC, and also other suitable thermoplastics. The polymer material to be processed can be in powder, liquid, cubed, pelletized form and/or any other form. The polymeric material can be virgin, recycled or a mixture of both. The polymeric material can be incorporated with a blowing agent to make a cellular foam structure core.

The natural fibers of flour have a specific moisture content, depending on the WPC-board specifications and requirements. The natural fibers can be from any wood source, cellulose source, other natural sources, or any combination thereof. Generally, any natural fiber can be used, which is from trees, plants, parts thereof and the like. The specific selection of a particular type of wood and/or wood fibers can have an influence on the properties of the final panel. The fibers of an exotic hard wood type could for example be substantially thicker and/or longer than normal fir wood. The bending stiffness will be higher if the WPC core is made with longer fibers. Synthetic fibers may also be used to enhance mechanical properties such as flexural and tensile modules of the product. The natural fiber or flour can be virgin, recycled or a mixture of both. Furthermore the natural fibers or flour can be incorporated with a foaming agent to make a cellular foam structure core.

The granulate supply mechanism may include a system provided by Schilling-Knobel GmbH, as is described in WO 99/26773, which is incorporated herein by reference thereto, including a hopper which is resting on a metering roller which picks up the material to be scattered on the conveyor belt. Other means are of course conceivable.

The upper and lower conveyor belt run over a certain length parallel to each other and include various zones. The first zone in the direction of conveyance of the conveyor belts is a heating zone. In this zone, the WPC granulate is heated to such temperature that the granulate melts to a sufficient extent in order to weaken to a mass which can be shaped into a solid continuous sheet. The heating temperature depends on the polymer used in the WPC granulate and can for example be between 180° C. and 250° C. The heating zone may be divided in a first heating zone and a second heating zone with nip rollers in between. These nip rollers are positioned below the transport part of the lower conveyer belt and above the transport part of the upper conveyor to effect a first pressing action on the layer of melted granulate. A second set of nip rollers consisting of two pairs of upper and lower nip rollers effects a final pressing action on the layer of melted granulate and determines the final thickness of the sheet to be formed.

If several layers 3 are used in the panel 1, these layers 3 are formed simultaneously or consecutively by means of devices, in particular scattering devices, that each provide a layer of granulates 5. The layers 3 can be pressed into a sheet after all layers have been provided, but it is also possible to first press a layer before another layer is scattered.

The sheet could be finished by an embossing step to provide the upper surface 2 of the sheet with the desired texture and/or glow. This can be done by textured rollers, press platens, belts and the like. The upper layer could also be formed by or provided with a granulate 5 that can generate chemical embossing. A substance (inhibitor) could be mixed into the granulate 5 that inhibits foaming when the granulate 5 is heated, as is widely used in the production of PVC/vinyl floorings. The pattern of the foaming agent or inhibitor determines the foamed/non-foamed zones, the distribution pattern can be random or predetermined.

The last zone within the conveyor belts may be an annealing zone by which the sheet layer is cooled and brought in its final form. At a position downstream of the upper conveyor belt there is arranged a cutting mechanism to cut the continuous sheet web into separate sheets which are then collected for further processing.

The upper surface 2 can be textured such as embossed in register with the design of the decoration in order to even better imitate natural material, such as (rag)stone, brick, ceramic, wood, marble or the like. Of course, it is also possible to provide the panels with a fantasy decoration. Embossing may be done simultaneously with printing, as is disclosed in U.S. Pat. No. 6,668,715. As an alternative or additionally, the raw WPC material can be chafed/sanded in a particular pattern, for example to further promote the imitation of natural materials such as wood or stone.

A backing layer may be provided below the core and is fixed to the underside of the core layer, possibly with interposition of a paper layer. The backing layer can be used as a balancing layer and it may also consist moisture resisting properties, although such properties may be integrated in one of the WPC layers.

At least on two opposite sides of the panels and preferably on all sides are formed coupling means to couple adjacent panels together. Preferably the coupling means also include a mechanical locking system to lock the adjacent panels not only in a direction perpendicular to the surface of the panels, but also in a direction parallel to the surface and perpendicular to the respective side of the panel. However the invention is not limited thereto at all. All coupling systems, including the use of adhesives is encompassed by the invention.

From the foregoing it follows that the invention provides panels for flooring or other coverings, such as wall and ceiling coverings, which have excellent qualities, such as acoustical characteristics (airborne as well as impact sound), a better water or humidity resistance (in comparison to MDF/HDF board), an anti or a-static behavior, and very good recycling properties, with maintenance of many of the qualities of MDF/HDF based laminate panels.

The invention is not limited to the embodiments shown in the drawings and described above, which may be varied in different manners within the scope of the invention. For example it is conceivable to combine the WPC layer with another layer of material. For example the complete core may include a base layer of a material such as HDF and a superposed layer of WPC. The connection between these layers can be accomplished after formation of the WPC, or the WPC layer can be formed on the base layer. Other layers may be combined with the WPC, either on, below or within the WPC layer. The WPC sheet may be formed in more than one pressing steps, for example to create several WPC layers within the sheet having different characteristics. For example a low density WPC layer may be sandwiched between layers of WPC having a higher density.

It is also possible to combine layers of WPC that have been optimized for various purposes. A layer may have favorable acoustic properties, for example by integrating cork, or selected types of polymers/wood fibers and/or by adding a foaming agent. Another layer may be antistatic or a-static. Another layer may be optimized for temperature or humidity induced expansion stability (for example by adding mineral fillers or varying the length, thickness and/or type of wood fibre), for water resistance, or for ease of machining. Another layer may consist of a layer having anti bacterial properties. A soft upper layer may promote deeper embossing, while a soft lower layer may enhance the equalizing capability.

Another option is to provide a basic layer which covers the whole area of the sheet to be formed. On this basic layer there is scattered particles or granules of material providing water resistance. This material is scattered only in the areas where the sheet will be cut, i.e. in the form of a framework having several windows, such that the edges of each panel to be formed will be formed by this water resistant material. In the windows of the framework, material can be scattered that provide other qualities such as acoustic absorption (e.g. cork). An upper (colored) layer may be provided over the whole area again. The selective scattering can be done by means of a scattering roll having a circumference corresponding with the length of a panel to be formed. The selective scattering can be obtained for example by selecting different particle sizes for the material to be scattered in different zones, and adapted to the scattering means of the scattering roll.

The upper WPC layer may be covered by a wear resistant varnish, for example a PU wear resistant resin and may optionally include anti-abrasive particles (for example corundum/aluminium oxide or other abrasive resistant hard particles as a finish. Also stone or brick dust can be used as anti-abrasive material, although this material may be used to obtain decorative effects as well. The particles may be scattered (while the top layer is melted lightly (IF)) so that the scattered particles will adhere to the top layer. Alternatively, the wear resistant particles may be embedded in or between the granulate particles. The use of a wear resistant polymer, for example certain types of PE, in the WPC already increases the wear resistance of the panel. Instead of WPC, also other mixtures of plastic and fibros or non-fibros material could be used in the invention.

1. A method of manufacturing floor panels comprising at least one layer containing wood/plastic composite (WPC) adjacent an upper surface of the panels, including:
providing a granulate of WPC in which natural fibers are encapsulated in polymer plastics which has been colored to a desired colour for the upper surface,
providing a layer of granulate and melting the granulate to fern a melted layer,
pressing the melted layer, together with any other layer, for forming a sheet,
finishing the sheet to form one or more panels.

2. The method according to claim 1, wherein fine particles are scattered onto the upper surface of the granulate of WPC.

3. The method according to claim 2, wherein the fine particles are colored and/or the particles are scattered in a desired pattern to obtain a decorative effect or to obtain different properties of the sheet in different areas.

4. The method according to claim 3, wherein first a basic layer is formed and then water resistant particles are scattered in zones where edges of the panels to be formed are projected, while particles having other properties are scattered in other zones, optionally an upper layer being scattered over the whole area.

5. The method according to claim 1, wherein the upper surface of the sheet is treated, for example by (hot) embossing, chafing and/or printing.

6. The method according to claim 1, wherein the laminate sheet is finished by cutting it into a plurality of panels and to machine the edges of the panels to form coupling and optionally locking members.

7. A panel having an upper surface, comprising:
at least one layer of wood/plastic composite (WPC) which is made from colored granulate, preferably to imitate natural materials at least on the upper surface of the panel.

8. The panel according to claim 7, comprising several layers, wherein only the top layer adjacent the upper surface of the panel is made from colored granulate.

9. The panel according to claim 7, wherein fine particles are provided on the upper surface of the panel.

10. The panel according to claim 9, wherein the fine particles are colored particles.

11. The panel according to claim 9, wherein the fine particles are wear-resistant particles, such as corundum.

12. The panel according to claim 7, wherein the WPC includes a wear resistant polymer, such as PE.

13. The panel according to claim 7, wherein thermo sensitive parts or pigments are mixed into the granulate.
